(19) United States
(12) Patent Application Publication
(10) Pub. No.: US 2006/0094624 A1
(43) Pub. Date: May 4, 2006

(54) Hard and soft surface cleaning agents

(76) Inventors: Tom Carrothers, Burlington (CA); Travis V. Day, Monroe, LA (US)

Correspondence Address: John M. Harrison, 2139 E. Bert Kouns, Shreveport, LA, 71105, US

(21) Appl. No.: 11/257,561

(22) Filed: Oct. 25, 2005

Related U.S. Application Data
(60) Provisional application No. 60/622,535, filed on Oct. 28, 2004.

(51) Int. Cl. C11D 3/00

(52) U.S. Cl. 510/392

(57) ABSTRACT

Cationic cleaning agents are introduced on and into absorbent material substrates such as absorbent paper, non-woven and woven cloth and sponges and such compositions are useful and effective individually or as a blend with ancillary surfactant agents, for cleaning various types of surfaces, including leather, plastic and metal surfaces.

### CROSS-REFERENCE TO RELATED APPLICATIONS

This application claims the benefit and incorporates by reference prior filed copending U.S. Provisional Application Ser. No. 60/622,535, Filed Oct. 28, 2004.

### SUMMARY OF THE INVENTION

Cleaners in powdered, liquid, aerosol and wipe formats have been utilized for many years for various applications. The active surfactants in these formulations tend to be anionic, nonionic, amphoteric and fairly recently, include a narrow range of cationic surfactants. Cationic surfactants, and particularly those that would normally be used for fabric softeners, are not compatible with anionic chemicals. Additionally, many cleaners utilize hazardous, environmentally unfriendly solvents for cleaning particularly difficult soils such as tar, asphalt, grease and oil from a variety of surfaces.

It has been found that conventional cationic sheet fabric softeners which are designed to soften and eliminate static when added to laundry loads, when wetted with water, act as very effective cleaning wipes on hard and soft surfaces, including vehicle finishes, both metal, plastic and leather, and are particularly effective against soils such as tar, asphalt, grease, oil and bugs that are splattered on such surfaces. It was also discovered that application of the cationic compositions and blends of this invention leaves a gloss or shine on the cleaned surfaces and acts to provide a transient protective coating against the elements.

Cationic surfactant cleaning agents such as difatty diamido ammonium methyl sulfate; ditallow dimethyl ammonium chloride; immidazolinium quats; and esterquats, in non-exclusive particular, can be applied to various absorbent substrates such as absorbent paper, sponges and woven and unwoven cloth, for cleaning various surfaces. These active cationic surfactants may be used individually or blended with ancillary surfactants such as ethoxylated alcohols, alkyl phenols, ethoxylated amines, tertiary phosphine oxides, tertiary amine oxides, fatty acid soaps and ethoxylated alcohol sulfates, as well as sodium alkyl sulfates, alkyl sulfonates, sodium alkylbenzenesulfonate and sodium and potassium alkyl glycerol ether sulfonates, in non-exclusive particular. Additional components such as fragrances, dyes, silicon compounds, brightening agents, soil repellents, fumigants, germicides and lubricants can be added to the above compositions for desired purposes.

Acceptable substrate materials which may be impregnated with the above blends include paper and sponges of varying thickness, as well as woven and non-woven cloth and the like, having a selected acceptable “free space” matrix suitable for absorbing the cleaning compositions. These compositions may include the cationic surfactants detailed herein or cationic blends of these surfactants and ancillary surfactants, typically in the range of from about 30% to about 70% of the cationic surfactants in the chemical blend and corresponding ancillary surfactant(s) or blends of ancillary surfactants, in the corresponding range of 70% to 30% of the chemical blend.

Moreover, the chemical cleaning agent or surfactant composition or blend is typically added to absorbent substrate materials such as those identified above, in a concentration of from about 100 grams per square meter to about 6 grams per square meter, and a preferred range of such addition is from about 48 grams per square meter to about 12 grams per square meter. The weight of the chemical or chemical blend absorbed depends upon the absorbability (free space) of the substrate chosen.

### DESCRIPTION OF THE PREFERRED EMBODIMENTS

Generally speaking, acceptable cationic surfactant compositions for use in this invention are those found in conventional sheet fabric softeners, which typically include a blend of cationic surfactants and ancillary surfactants to improve the release of the cationic surfactants. These chemicals are blended and added to traditional absorbent substrates by methods which include, but are not limited to, padding, dipping, roller application and spraying, as hereinafter described. Such substrates can include, but are not limited to, absorbent paper, polyester, sponges, cotton and blends of these materials, as further hereinafter described.

The cationic surfactant cleaning materials of this invention are typically marketed for various non-cleaning purposes as solids, paste or liquids, some in aqueous or aqueous-alcohol solution or in other dispersion forms known to those skilled in the art. The selected substrate is typically coated or impregnated with the cleaning agent or agents by, for example, immersion in a suitable liquid solvent containing the agent or agents, as further hereinafter described. The receiving substrates are preferably provided in the shape or form of a cellulosic sheet material such as conventional perforated paper arranged in a roll or towel, or in a package from which swatches or sheets can be removed. Fabrics such as flannel can also be packaged for removal one at a time. Suitable ancillary agents typically include water or water-alcohol mixtures, including isopropyl alcohol, in non-exclusive particular, for economy as solvents. To incorporate the cleaning agent compositions into the paper, woven or non-woven or felted substrates, the selected substrate is immersed in a solution or dispersion of the composition having a concentration sufficient to provide the desired quantity of cleaning agent on or in the substrate. Alternatively, the substrate can be coated and/or impregnated with the agent composition using substantially any conventional roll applicator which meters the material onto the substrate, where it may be absorbed into the substrate in proportion to the “free space” therein. The solvent may then be removed from the substrate by drying, either at ambient temperature or by oven drying. The resulting treated substrate can then be distributed in a perforated roll form or a package, from which individual sheets can either be readily detached or withdrawn, with each sheet carrying a desired predetermined concentration of cleaning agent.

It will be appreciated by those skilled in the art that the term “cloth” as used herein includes both woven and non-woven fabric or cloth used as a cleaning agent substrate. Accordingly, essential to the invention is the use of at least a flexible substrate and most preferably, a flexible and absorbent one. Such a substrate must, in a preferred embodiment of the invention, be able to absorb a liquid cleaning substance or agent and, in a most preferred embodiment, have an absorbent capacity (values representing the substrate propensity to retain a liquid) from about 5.5 to about 12 times the weight of water.

In the case of non-woven cloth substrates which may be used in the invention, these substrates are defined as adhesively bonded fibrous or filamentous products having a web or carded fiber structure (under circumstances where the fiber strength is suitable for carding), or including fibrous mats, in which the fibers or filaments are distributed in random array in the cloth matrix. The fibers or filaments can be natural, for example, wools, silks, jute, hemp, cotton, linen, sisal, or synthetic, such as rayon, cellulose ester, polyvinyl derivatives, poly-olefins, poly-amides, or polyesters. The absorbent properties of the substrates required in the invention are particularly easy to obtain using non-woven cloths and these properties can be adjusted by increasing the thickness of the cloth or by superimposing multiple, carded webs or mats to a thickness adequate to obtain the necessarily absorbent (free space) properties. Critical to such laminate construction is the free space between each fiber, which makes the thickness of the cloth directly related to the absorbent capacity of the cloth, and which also makes the non-woven cloth especially suitable for impregnation with a cleaning agent by means of capillary action. Accordingly, multiple desired thickness and free space conditions necessary to obtain the required absorbency of the treating agent can be achieved by this layering technique.

When the substrate element of the cleaning composition and agents used in this invention is a non-woven cloth made from fibers arranged haphazardly or in random array in the cloth matrix, the compositions and substrate combinations exhibit excellent mechanical strength in all directions and are not prone to tear or separate excessively by friction and wear when used to clean the various types of surfaces indicated herein. It is also significant and will be appreciated by those skilled in the art, that the absorbent substrates which receive the various cleaning agents and compositions herein may take a variety of shapes and forms. For example, the substrates can be in the shape of balls or puffs, or may be characterized by sheets or swatches of woven or non-woven cloth. When the substrate is paper or cloth, individual sheets of desired length and width can be used, or if paper, a continuous perforated roll of desired width, from which a measured length is torn can be employed in a preferred embodiment of the invention.

The cleaning agents or compositions of this invention can be used singularly or add-mixed with one or more compatible surfactant carriers, as described above. In a most preferred embodiment of the invention acceptable cationic materials which may be used in the invention are as described above and include difatty diamido ammonium methyl sulfate; ditallow dimethyl ammonium chloride, immidazolinium quats; and esterquats, in non-exclusive particular. Specific esterquats which are preferred for use as cleaning agents are as follows: dialkyl dimethyl ammonium chloride; methyl bis(hydrogenated tallow amidoethyl)-2-hydroxyethyl ammonium methyl sulfate; methyl bis(tallowamido ethyl)-2-hydroxyethyl ammonium methyl sulfate; methyl bis(soya amidoethyl)-2-hydroxyethyl ammonium methyl sulfate; methyl bis(cannola amidoethyl)-2-hydroxyethyl ammonium methyl sulfate; methyl bis(tallowamido ethyl)-2-tallow imidazolinium methyl sulfate; methyl bis(hydrogenated tallowamido ethyl)-2-hydrogenated tallow; imidazolinium methyl sulfate; methyl bis (tallowamido ethyl)-2-tallow imidazolinium methyl sulfate; methyl bis(ethyl tallowate)-2-hydroxyethyl ammonium methyl sulfate; methyl bis(ethyl tallowate)-2-hydroxyethyl ammonium methyl sulfate; ditallow dimethylammonium chloride (DTDMAC); dihydrogenated tallow dimethylammonium chloride; dihydrogenated tallow dimethylammonium methylsulfate; distearyl dimethylammonium chloride; dioleyl dimethylammonium chloride; dipalmityl hydroxyethyl methylammonium chloride; stearyl benzyl dimethylammonium chloride; tallow trimethylammonium chloride; tallow trimethylammonium chloride; hydrogenated tallow trimethylammonium chloride; C.sub 12-14 alkyl hydroxyethyl dimethylammonium chloride; C.sub 12-18 alkyl dihydroxyethyl methylammonium chloride; ditallow imidazolinium methylsulfate; 1-(2-tallowyca midoethyl)-2-tallowyl imidzolinium methylsulfate; N,N-di(tallowyl-oxy-ethyl)-N,N-dimethyl ammonium chloride; N,N-di(tallowyl-oxy-ethyl)-N-methyl,N-(2-hydroxyethyl) ammonium chloride; N,N-di(2-tallowyl-oxy-2-oxo-ethyl)-N,N-dimethyl ammonium chloride; N,N-di(2-tallowyl-oxy-ethylcarbonyl-oxy-ethyl)-N,N-dimethyl ammonium chloride; N-(2-tallowyl-oxy-2-ethyl)-N-(2-tallowyl-oxy-2-oxo-ethyl)-N,N-dimethyl ammonium chloride; N,N,N-tri(tallowyl-oxy-ethyl)-N-methyl ammonium chloride; N-(2-tallowyl-oxy-2-oxo-ethyl)-N-(talowyl-N,N-dimethyl-ammonium chloride; N-methyl-N-(3-tallowadmiopropyl),N-(2-tallowoyloxyethyl)ammonium chloride; 1,2-ditallowyl-oxy-3-trimethylammoniopropane chloride.

The above noted cationic agents may also be used with the above-noted ancillary surfactant chemicals, including ethoxylated alcohols; alkyl phenols; ethoxylated amines; tertiary phosphine oxides; tertiary amine oxides; fatty acid soaps; ethoxylated alcohol sulfates; sodium alkyl sulfates; alkyl sulfonates; sodium alkyl benzenesulfonate; and sodium or potassium alkyl glycerol ether sulfonates.

Specific examples of particular suitable non-ionic surfactants are straight-chained, primary alcohol alkoxylates such as tallowalcohol-EO(11), tallowalcohol-EO(18), and tallowalcohol-EO(25); straight-chained, secondary alcohol alkoxylates such as 2-C.Sub.16-EO (11); 2-C.Sub.20-EO(11); and 2-C.Sub.16-EO (14).

Alkylphenol alkoxylates, such as P-tridecylphenoleo (11) and P-pentadecylphenol EO (18), as well as olefinic alkoxylates and branched chain alkoxylates such as branch chain primary and secondary alcohol which are available from the well known “OXO” process.

Suitable amine oxides for use in the cleaning agent composition include those with one alkyl or hydroxyalkyl moiety of 8-28 carbon atoms, preferably from 8-16 carbon atoms and two alkyl moieties selected from alkyl groups and hydroxalkyl groups with 1-3 carbon atoms. Examples include dimethylocylamine oxide; dimethyldecylamine oxide; bis-(2-hydroxyethyl) dodecylamine oxide; dimethylidodecyl-amine oxide; dipropyltetradecyl amine oxide; methylethlhexadecyl amine oxide; dimethyl-2-hydroxyoctadecyl amine oxide; and coconut fatty alkyl dimethyl amine oxide.

Suitable fatty acids for use in composition include those containing from about 10-25 total carbon atoms, with the fatty moiety containing from about 10-22 carbon atoms. The shorter moiety contains from about 1-4 and preferably from about 1-2 carbon atoms. Specific examples of fatty acid compounds include compounds selected from loric acid, myristic acid, acid palmitic, stearic acid, arachidic acid, vehenic acid, oleic acid, coconut fatty acid, tallow fatty acid, partially hydrogenated tallow fatty acid and mixtures thereof.

It will be further appreciated by those skilled in the art that blends of the cationic agents themselves, as well as blends which include one or more ancillary surfactants, can be utilized in the invention to coat or impregnate various absorbent substrates according to the procedures outlined herein, as well as other techniques known to those skilled in the art. Moreover, other additives such as selected fragrances, dyes, silicon compounds, brightening agents, soil repellent fumigates, germicides, lubricants and the like may also be added to the blends as desired, for various purposes. These chemical blends typically include composition blends in the range of 30% to 70% of the chemical blend by volume and ancillary surfactants or blends of ancillary surfactants in the range of 70% to 30% of the chemical blend by volume. In a most preferred embodiment of the invention the chemical blend and/or the chemical and ancillary chemicals may be added in the above proportions individually or in a selected blend to the various substrates outlined above, in the amount of between about 100 grams per square meter to about 6 grams per square meter, with the preferred range being from about 48 grams per square meter to about 12 grams per square meter. Depending upon the absorbability of the substrates, the range can be even larger, as determined by experimentation.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A cleaning composition comprising at least one cationic surfactant applied to a substrate, said cationic surfactant selected from the group consisting of difatty diamido ammonium methyl sulfate; ditallow dimethyl ammonium chloride; immidazolinium quats; and esterquats.

2. The cleaning composition of claim 1 wherein said substrate is selected from the group consisting of paper, sponges, woven cloth and non-woven cloth.

3. The cleaning composition of claim 1 comprising at least one ancillary surfactant selected from the group consisting of ethoxylated alcohols; alkyl phenols; ethoxylated amines; tertiary phosphine oxides; tertiary amino oxides; fatty acid soaps; ethoxylated alcohol sulfates; sodium alkyl sulfates; alkyl sulfonates; sodium alkylbenzenesulfonate; sodium alkyl glycerol ether sulfonates; and potassium alkyl glycerol ether sulfonates.

4. The cleaning composition of claim 3 wherein said at least one cationic surfactant is present in said composition a range of from about 30% to about 70% by volume.

5. The cleaning composition of claim 4 wherein said substrate is selected from the group consisting of paper, sponges, woven cloth and non-woven cloth.

6. The cleaning composition of claim 1 comprising water.

7. The cleaning composition of claim 6 comprising at least one ancillary surfactant selected from the group consisting of ethoxylated alcohols; alkyl phenols; ethoxylated amines; tertiary phosphine oxides; tertiary amino oxides; fatty acid soaps; ethoxylated alcohol sulfates; sodium alkyl sulfates; alkyl sulfonates; sodium alkylbenzenesulfonate; sodium alkyl glycerol ether sulfonates; and potassium alkyl glycerol ether sulfonates.

8. The cleaning composition of claim 7 wherein said substrate is selected from the group consisting of paper, sponges, woven cloth and non-woven cloth.

9. The cleaning composition of claim 8 wherein said at least one cationic surfactant is present in said composition a range of from about 30% to about 70% by volume.

10. A method for cleaning a surface comprising the steps of providing a flexible substrate, contacting the substrate with at least one cationic surfactant and rubbing the substrate across the surface.

11. The method of claim 10 comprising the step of wetting the substrate with water before rubbing the substrate across the surface.

12. The method according to claim 10 comprising the step of at least partially impregnating the flexible substrate with the cationic surfactant.

13. The method of claim 12 comprising the step of wetting the substrate with water before rubbing the substrate across the surface.

14. The method according to claim 10 comprising the step of adding an ancillary surfactant to the cationic surfactant to define a selected cationic surfactant-ancillary surfactant composition.

15. The method of claim 14 comprising the step of wetting the substrate with water before rubbing the substrate across the surface.

16. The method according to claim 15 wherein the cationic surfactant is present in the cationic surfactant-ancillary surfactant composition in a range of from about 30% to about 70% by volume.

17. The method according to claim 14 comprising the step of at least partially impregnating the flexible substrate with the cationic surfactant-ancillary surfactant composition.

18. The cleaning composition of claim 17 comprising the step of wetting the substrate with water before rubbing the substrate across the surface.

19. The cleaning composition of claim 18 comprising the step of at least partially impregnating the flexible substrate with the cationic surfactant.

20. The cleaning composition of claim 19 wherein the cationic surfactant is present in the cationic surfactant-ancillary surfactant composition in a range of from about 30% to about 70% by volume.
